(19) United States
(12) Patent Application Publication
(10) Pub. No.: US 2022/0089142 A1
(43) Pub. Date: Mar. 24, 2022

(54) VEHICLE DRIVE ROUTE INSTRUCTION SYSTEM

(71) Applicant: TOYOTA JIDOSHA KABUSHIKI KAISHA, Aichi-ken (JP)

(72) Inventors: Daiki YOKOYAMA, Gotemba-shi (JP); Hiroya CHIBA, Susono-shi (JP); Yoshiyuki KAGEURA, Sunto-gun (JP); Masanori SHIMADA, Susono-shi (JP); Yoshihiro SAKAYANAGI, Mishima-shi (JP)

(21) Appl. No.: 17/443,458

(22) Filed: Jul. 27, 2021

(30) Foreign Application Priority Data
Sep. 23, 2020 (JP) 2020-158623

(51) Int. Cl. B60W 20/12; G01C 21/34; B60K 6/26; B60W 50/14; G01C 21/36; B60W 60/00

(52) U.S. Cl. CPC B60W 20/12; G01C 21/3469; B60K 6/26; B60W 50/14; B60Y 2200/92; B60W 60/001; B60W 2510/244; B60W 2050/146; G01C 21/3629

(57) ABSTRACT

A vehicle drive route instruction system in a hybrid vehicle in which when it is judged that currently the vehicle is driving through the inside of the engine drive restriction zone where driving by the internal combustion engine is restricted, the internal combustion engine is made to stop operating, the electric motor is used to drive the vehicle, and the shortest route from the current position to the boundary of the inside of the engine drive restriction zone and the outside of the engine drive restriction zone is searched. When it is judged that the SOC amount will fall to the preset judgment standard when driving the vehicle through the searched shortest route from the current position to the boundary, an occupant of the vehicle is given information to guide the vehicle from the current position through the searched shortest route to the boundary.

### FIELD

The present invention relates to a vehicle drive route instruction system.

### BACKGROUND

Known in the art has been a hybrid vehicle provided with a power generation use or drive use internal combustion engine, a battery charged by the power generation action of the generator driven by the internal combustion engine or regenerative control, and a battery driven electric motor, wherein when the vehicle passes through the inside of a strengthened air pollution prevention region, the internal combustion engine is made to stop operating and the electric motor is used to drive the vehicle (for example, see Japanese Unexamined Patent Publication No. 7-75210). In this hybrid vehicle, if an amount of charge of the battery falls to a lower limit value, the battery is charged by the power generation action of the generator driven by the internal combustion engine and the lower limit value of the amount of charge of the battery is set high so that the amount of charge of the battery does not become insufficient while the vehicle is passing through the strengthened air pollution prevention region.

### SUMMARY

However, even if the lower limit value of the amount of charge of the battery is set high in this way, for example, if the vehicle continues to be driven inside the strengthened air pollution prevention region, the amount of charge of the battery will fall, that is, the SOC (state of charge) amount showing the amount of charge of the battery will fall while the vehicle is driven through the inside of the strengthened air pollution prevention region and a situation is liable to arise where driving the vehicle by the electric motor will become difficult so long as not driving the internal combustion engine. However. the above Patent Publication does not suggest at all a method for avoiding the occurrence of such a situation.

The present invention provides a vehicle drive route instruction system able to avoid the occurrence of such a situation.

According to the present invention, there is provided a vehicle drive route instruction system in a hybrid vehicle driven by only an electric motor or driven by both an electric motor and an internal combustion engine, the vehicle drive route instruction system comprising:
an SOC amount acquiring unit acquiring an SOC amount of a battery which is a source of supply of electric power to the electric motor,
a vehicle position detecting unit detecting a current position of the vehicle,
a zone judging unit judging if currently the vehicle is driving through an inside of an engine drive restriction zone where driving by the internal combustion engine is restricted,
an operation control unit making the internal combustion engine stop operating and making the electric motor drive the vehicle when it is judged that currently the vehicle is driving through the engine drive restriction zone,
a shortest route searching unit searching for a shortest route from the current position to a boundary of an inside of the engine drive restriction zone and an outside of the engine drive restriction zone when it is judged that currently the vehicle is driving through the inside of the engine drive restriction zone,
a decreased SOC amount calculating unit calculating a decreased SOC amount when driving the vehicle through the searched shortest route from the current position to the boundary,
an SOC amount judging unit judging if the SOC amount will fall to a preset judgment standard based on the current SOC amount and the calculated decreased SOC amount when driving the vehicle through the searched shortest route from the current position to the boundary based, and
a guidance device giving information to an occupant of the vehicle to guide the vehicle from the current position through the searched shortest route to the boundary in case where it is judged that the SOC amount will fall to the judgment standard when driving the vehicle through the searched shortest route from the current position to the boundary.

Further, according to the present invention, there is provided a vehicle drive route instruction system in a hybrid vehicle driven by only an electric motor or driven by both an electric motor and an internal combustion engine, the vehicle drive route instruction system comprising:
an SOC amount acquiring unit acquiring an SOC amount of a battery which is a source of supply of electric power to the electric motor,
a vehicle position detecting unit detecting a current position of the vehicle,
a zone judging unit judging if currently the vehicle is driving through an inside of an engine drive restriction zone where driving by the internal combustion engine is restricted,
an operation control unit making the internal combustion engine stop operating and making the electric motor drive the vehicle when it is judged that currently the vehicle is driving through the engine drive restriction zone,
a shortest route searching unit searching for a shortest route from the current position to a boundary of an inside of the engine drive restriction zone and an outside of the engine drive restriction zone when it is judged that currently the vehicle is driving through the inside of the engine drive restriction zone,
a decreased SOC amount calculating unit calculating a decreased SOC amount when driving the vehicle through the searched shortest route from the current position to the boundary,
an SOC amount judging unit judging if the SOC amount will fall to a preset judgment standard based on the current SOC amount and the calculated decreased SOC amount when driving the vehicle through the searched shortest route from the current position to the boundary based, and
a self driving device autonomously driving the vehicle through the searched shortest route from the current position to the boundary in case where it is judged that the SOC amount will fall to the judgment standard when driving the vehicle through the searched shortest route from the current position to the boundary.

In the first aspect of the invention, it is possible to guide the vehicle so that the vehicle does not become unable to be driven inside the engine drive restriction zone, while in the second aspect of the invention, the vehicle operation is controlled so that the vehicle does not become unable to be driven inside the engine drive restriction zone.

### BRIEF DESCRIPTION OF DRAWINGS

FIG. 1 is an overall view of a vehicle schematically shown.

FIG. 2A and FIG. 2B are views of the configuration of a vehicle drive unit.

FIG. 3 is a view for explaining an SOC amount.

FIG. 4 is a flow chart for charging control.

FIG. 5 is a view schematically showing a road map.

FIG. 6 is a view showing the SOC amount.

FIG. 7 is a view showing a vehicle and server shown schematically.

FIG. 8 is a view of the functional configuration of a vehicle drive route instruction system according to the present invention.

FIG. 9 is a flow chart for vehicle control.

FIG. 10 is a view of the functional configuration of another embodiment of the vehicle drive route instruction system according to the present invention.

FIG. 11 is a flow chart for self driving control.

FIG. 12 is a flow chart for self driving control.

### DESCRIPTION OF EMBODIMENTS

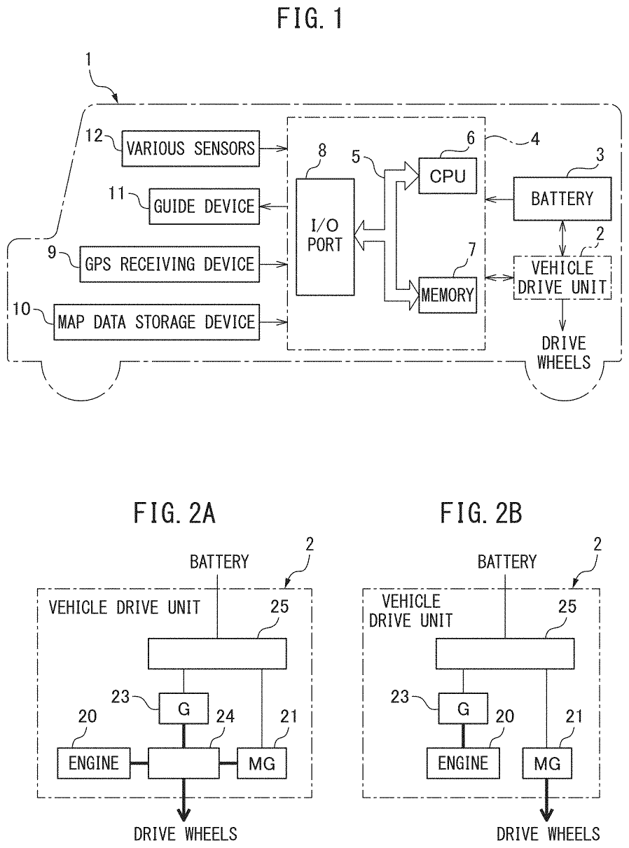

Referring to FIG. 1, 1 shows a hybrid vehicle driven by only an electric motor or driven by both an electric motor and an internal combustion engine. Further, in FIG. 1, 2 indicates a vehicle drive unit for providing drive force to the drive wheels, 3 indicates a battery, and 4 indicates an electronic control unit mounted in the vehicle 1. As shown in FIG. 1, the electronic control unit 4 is comprised of a digital computer provided with a CPU (microprocessor) 6, a memory 7 comprised of a ROM and RAM, and an input/output port 8, which are connected to each other via a bidirectional bus 5.

Further, inside the vehicle 1, a GPS (global positioning system) receiving device 9 for receiving signals from satellites to detect the current position of the vehicle 1, a map database storage device 10 storing a map database etc., and a guidance device 11 comprised of a navigation system for guiding the vehicle 1 to a destination are mounted. Furthermore, inside the vehicle 1, an accelerator opening degree sensor, engine rotational speed sensor, vehicle speed sensor, atmospheric temperature sensor, atmospheric pressure sensor, or other various sensors 12 are mounted. These GPS receiving device 9, map database storage device 10, guidance device 11, and various sensors 12 are connected to the electronic control unit 4.

FIG. 2A and FIG. 2B are views of the configuration of the vehicle drive unit 2 shown in FIG. 1, showing typical hybrid systems of respectively different formats. These hybrid systems are well known, so will be explained extremely simply. First, referring to FIG. 2A, the vehicle drive unit 2 is provided with an internal combustion engine 20, an electric motor 21, a generator 23, a power distribution mechanism 24 comprised of for example a planetary gear mechanism, and a motor control device 25. The electric motor 21 performs the role of a generator, so is usually called a “motor-generator”. For example, at the time of low speed driving, the vehicle 1 is driven by the electric motor 21. At this time, electric power is supplied from the battery 3 through the motor control device 25 to the electric motor 21 while the output of the electric motor 21 is transmitted by the power distribution mechanism 24 to the drive wheels.

On the other hand, at the time of medium or high speed driving, the vehicle 1 is driven by the internal combustion engine 20 and electric motor 21. At this time, on the one hand, part of the output of the internal combustion engine 20 is transmitted by the power distribution mechanism 24 to the drive wheels, while on the other hand, part of the output of the internal combustion engine 20 is used to drive the generator 23, the generated electric power of the generator 23 is used to drive the electric motor 21, and the output of the electric motor 21 is transmitted by the power distribution mechanism 24 to the drive wheels. Further, at the time of braking the vehicle 1, the electric motor 21 functions as a generator, and a regenerative control in which the battery 3 is charged by the generated electric power of the electric motor 21 is performed. Further, if the amount of charge of the battery 3 falls, the generator 23 is driven through the power distribution mechanism 24 by the internal combustion engine 20, and the battery 3 is charged by the generated electric power of the generator 23.

Next, referring to FIG. 2B, the vehicle drive unit 2 is provided with the internal combustion engine 20, electric motor 21, generator 23, and motor control device 25. In the hybrid system shown in FIG. 2B, the electric motor 21 performs the role of a generator, so usually is called a “motor-generator”. In this hybrid system, the vehicle 1 is constantly driven by the electric motor 21. On the other hand, if the amount of charge of battery 3 falls, the generator 23 is driven by the internal combustion engine 20, and the battery 3 is charged by the generated electric power of the generator 23. Further, in this hybrid system as well, at the time of braking the vehicle 1, the electric motor 21 functions as a generator, and a regenerative control in which the battery 3 is charged by the generated electric power of the electric motor 21 is performed. In the hybrid system shown in either of FIG. 2A and FIG. 2B as well, the internal combustion engine 20 and the power distribution mechanism 24 are controlled by the output signal of the electronic control unit 4 while the electric motor 21 and generator 23 are controlled by the motor control device 25 based on the output signals of the electronic control unit 4.

In this regard, if referring to the mode where the vehicle 1 is driven by only the electric motor 21 as the EV mode and referring to the mode where the vehicle 1 is driven by both of the internal combustion engine 20 and electric motor 21 as the HV mode, in the hybrid vehicle 1 provided with the hybrid system shown in FIG. 2A, the mode is selectively switched to either of the EV mode and the HV mode. On the other hand, in the hybrid vehicle 1 provided with a hybrid system shown in FIG. 2B, the vehicle 1 is driven by only the electric motor 21, and the internal combustion engine 20 is used only for driving the generator 23 and charging the battery 3, so in this vehicle 1, the drive mode of the vehicle 1 is always made the EV mode. Note that, the hybrid system shown in FIG. 2A and FIG. 2B is a typical example. In the present invention, various types of hybrid systems can be used. Note that, below, the present invention will be explained centered about the case of using the hybrid system shown in FIG. 2A.

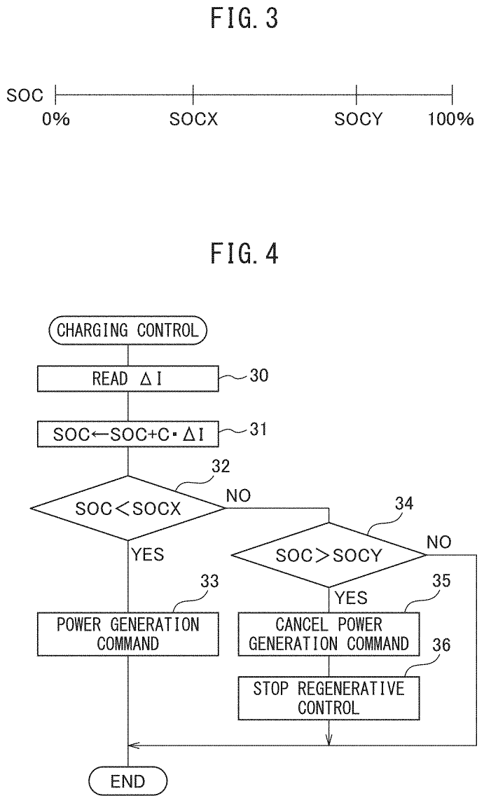

FIG. 3 shows the SOC (state of charge) amount expressing the amount of charge of the battery 3. In FIG. 3, when the amount of charge of the battery 3 is a full charge, the SOC amount becomes 100% while when the amount of charge of the battery 3 is zero, the SOC amount becomes 0%. Further, in the hybrid system shown in FIG. 2A and FIG. 2B, for example, if the amount of charge falls to a preset lower limit value SOCX, the generator 23 is driven by the internal combustion engine 20 until the amount of charge rises to a preset upper limit value SOCY, and a charging action of the battery 3 is performed by the generated electric power of the generator 23. Note that, below, the SOC amount will sometimes be simply expressed by “SOC”. Note that, the amounts of current outflow from and inflow to the battery 3 and the output voltage of the battery 3 are constantly detected, and the SOC amount is calculated based on the detected amounts of current outflow from and inflow to the battery 3 etc. in the electronic control unit 4.

FIG. 4 shows the charging control routine of a battery 3 performed by the electronic control unit 4. This charging control routine is executed by interruption every fixed time period.

Referring to FIG. 4, first, at step 30, the amount of inflow of current ΔI to the battery 3 in a fixed time period is read. Next, at step 31, the product of the amount of inflow of current ΔI to the battery 3 in a fixed time period and a constant C is added to the SOC amount SOC. Note that, when current flows out from the battery 3, the amount of inflow of current ΔI becomes a minus value. Note that, the method of calculation of the SOC amount SOC is only shown by an extremely simple example. Various known methods of calculation of the SOC amount SOC can be used.

Next, at step 32, it is judged if the SOC amount SOC falls below the preset lower limit value SOCX. When it is judged that the SOC amount SOC falls below the preset lower limit value SOCX, the routine proceeds to step 33 where a power generation command is issued. If the power generation command is issued, the generator 23 is driven by the internal combustion engine 20 and the action of charging the battery 3 is performed by the generated electric power of the generator 23. On the other hand, when it is judged at step 32 that the SOC amount SOC does not fall below the preset lower limit value SOCX, the routine proceeds to step 34 where it is judged if the SOC amount SOC exceeds the preset upper limit value SOCY. When it is judged that the SOC amount SOC exceeds the preset upper limit value SOCY, the routine proceeds to step 35 where the power generation command is cancelled. If the power generation command is cancelled, drive of the generator 23 by the internal combustion engine 20 is stopped and the action of charging the battery 3 by the generator 23 is stopped. Next, at step 36, regenerative control is stopped.

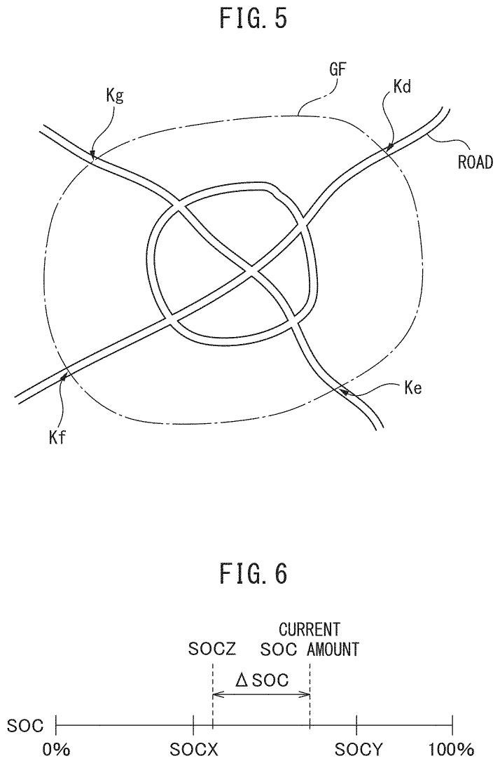

Now then, in recent years, from the viewpoint of prevention of air pollution, from the viewpoint of noise prevention, or from other viewpoints, an increasing number of countries have been establishing engine drive restriction zones restricting driving by internal combustion engines and drafting regulations prohibiting driving by internal combustion engines in such engine drive restriction zones. FIG. 5 schematically shows a boundary GF between an inside of an engine drive restriction zone and an outside of the engine drive restriction zone, which is set in a certain region. The inside of this boundary GF is made the engine drive restriction zone. This boundary GF is usually called “geofencing”. This boundary GF is sometimes fixed and sometime fluctuates in position due to the state of air pollution or some other reason.

In FIG. 5, Kd, Ke, Kf, and Kg show positions of the roads on the boundary GF. The road positions Kd, Ke, Kf, and Kg positioned on the boundary GF are sometimes provided with gates. In this case, the occupant of the vehicle 1 can recognize he or she has entered an engine drive restriction zone by the vehicle 1 passing through these gates. Further, at this time, if an apparatus installed at the gate emits a signal showing that the vehicle 1 has entered inside the engine drive restriction zone, it is possible to recognize that the vehicle 1 has entered the inside of the engine drive restriction zone by receiving this signal. Further, if electronic boundary position data showing the position of this boundary GF can be acquired, for example, it is possible to recognize that the vehicle 1 has entered the inside of the engine drive restriction zone by displaying the boundary position on the map screen based on this boundary position data.

In this regard, when the vehicle 1 enters inside the engine drive restriction zone, driving by the internal combustion engine 20 is prohibited, so the internal combustion engine 20 must be made to stop operating and the electric motor 21 must be used to drive the vehicle 1. In this regard, if using the electric motor 21 to drive the vehicle 1, if the SOC amount SOC falls below the preset lower limit value SOCX while the vehicle 1 is driving through the inside of the engine drive restriction zone, the internal combustion engine 20 has to be used to drive the generator 23 to charge the battery 3 by the electric power generated by the generator 23. However, inside the engine drive restriction zone, driving by the internal combustion engine 20 is prohibited, so it is not possible to drive the internal combustion engine 20 and as a result there is the problem that it is no longer possible to drive the vehicle 1.

Therefore, in the first embodiment according to the present invention, to keep such a problem from arising, when it is judged that the vehicle 1 is driving through the inside of the engine drive restriction zone, the shortest route from the current position to the boundary GF continues to be searched, and the decreased SOC amount when driving the vehicle through the searched shortest route from the current position to the boundary GF continues to be calculated, it continues to be judged from the current SOC and the calculated decreased SOC amount whether the vehicle 1 can reach the boundary GF before the SOC amount falls below the preset lower limit value SOCX when driving the vehicle 1 through the searched shortest route from the current position toward the boundary GF, that is, whether the SOC amount will fall to a preset judgment standard slightly larger than the preset lower limit value SOCX when driving the vehicle 1 through the searched shortest route from the current position to the boundary GF, and when it is judged that the SOC amount will fall to the judgment standard when driving the vehicle 1 through the searched shortest route from the current position to the boundary GF, the occupant of the vehicle 1 is given information and the vehicle 1 is guided from the current position through the searched shortest route to the boundary GF.

FIG. 6 shows the relationship among the current SOC amount, the decreased SOC amount ΔSOC, and the judgment standard SOCZ when it is judged that the SOC amount will fall to the judgment standard when driving the vehicle 1 through the searched shortest route from the current position to the boundary GF. Note that, FIG. 6 shows the SOC amount similar to FIG. 3, and accordingly, as explained referring to FIG. 3, if the SOC amount falls to the preset lower limit value SOCX, the generator 23 is driven by the internal combustion engine 20 until the SOC rises to the preset upper limit value SOCY.

Now then, the SOC amount when the vehicle 1 reaches boundary GF is the value of the current SOC minus the decreased SOC amount ΔSOC (current SOC−ΔSOC). Therefore, in the first embodiment according to the present invention, when the SOC amount when the vehicle 1 reaches the boundary GF (current SOC−ΔSOC) becomes the judgment standard SOCZ such as shown in FIG. 6, the occupant of the vehicle 1 is given information and the vehicle 1 is guided from the current position through the searched shortest route to the boundary GF. In this case, in the first embodiment according to the present invention, the decreased SOC amount ΔSOC is found by calculation considering the road conditions of the shortest route from the current position to the boundary GF.

In this regard, if the vehicle 1 reaches the boundary GF and is positioned outside of the engine drive restriction zone, the internal combustion engine 20 can be used to drive the generator 23, so it is also possible to use the preset lower limit value SOCX as the judgment standard SOCZ. However, as an actual problem, it is difficult to accurately calculate the decreased SOC amount ΔSOC. Therefore, in the first embodiment according to the present invention, the value of the preset lower limit value SOCX plus a fixed value is made the judgment standard SOCZ so that the judgment standard SOCZ does not become below the preset lower limit value SOCX even if the calculated value of the decreased SOC amount ΔSOC deviates somewhat from the actual decreased SOC amount. In this case, in the first embodiment according to the present invention, this fixed value is made a predetermined percentage of 10% or less. Therefore, in FIG. 3, the judgment standard SOCZ is made the value of the preset lower limit value SOCX plus a predetermined percentage of 10% or less.

On the other hand, as will be understood from FIG. 6, the SOC amount (current SOC−ΔSOC) when the vehicle 1 reaches the boundary GF becoming the judgment standard SOCZ means that the current SOC becomes the value (SOCZ+ΔSOC) of the judgment standard SOCZ plus the decreased SOC amount ΔSOC. Therefore, in the first embodiment according to the present invention, by judging whether the current SOC becomes lower than the value (SOCZ+ΔSOC) of the judgment standard SOCZ plus the decreased SOC amount ΔSOC, it is judged whether the SOC amount will fall to the preset judgment standard SOCZ when driving the vehicle 1 through the searched shortest route from the current position to the boundary GF. When it is judged that the current SOC falls below the value (SOCZ+ΔSOC) of the judgment standard plus the calculated decreased SOC, the occupant of the vehicle 1 is given information to guide the vehicle 1 from the current position through the searched shortest route to the boundary GF.

On the other hand, as explained above, the guidance device 11 is comprised of a navigation system. When it is judged that the SOC amount will fall to the preset judgment standard SOCZ when driving the vehicle 1 through the searched shortest route from the current position to the boundary GF, the guidance device 11 imparts information to the occupant of the vehicle 1 to guide the vehicle 1 from the current position through the searched shortest route to the boundary GF. In this case, as one example, the guidance device 11 is provided with a display unit displaying the driving route of the vehicle 1, that is, a display screen of the navigation system. When it is judged that the SOC amount will fall to the preset judgment standard SOCZ when driving the vehicle 1 through the searched shortest route from the current position to the boundary GF, this display unit, that is, the display screen of the navigation system, is made to display the searched shortest route and to display the fact that the vehicle 1 should head toward the outside of the engine drive restriction zone since it is liable to become unable to be driven.

Further, in another example, the guidance device 11 is provided with a speech generating unit explaining the driving route of the vehicle by voice. When it is judged that the SOC amount will fall to the preset judgment standard SOCZ when driving the vehicle through the searched shortest route from the current position to the boundary GF, the vehicle 1 is liable to become unable to be driven, so a warning is issued by voice to the effect that the vehicle should head to outside of the engine drive restriction zone and the searched shortest route is guided along by voice.

Next, one example of the method of calculation of the decreased SOC amount ΔSOC will be explained. The energy EX consumed through the searched shortest route from the current position to the boundary GF, as shown by the following formula, becomes the sum of the loss Ef due to friction from the current position until reaching the boundary GF, the amount of change ΔEh of the potential energy, and the amount of change ΔEv of the kinetic energy:

EX=Ef+ΔEh+ΔEv

Now then, the loss Ef due to friction becomes the integral value of the loss “f” due to friction at any instant from the current position until reaching the boundary GF. Here, if “v” is the vehicle speed, the loss “f” due to friction at any instant is expressed by a quadratic expression of the vehicle speed “v” as in the following formula:

f=av²+bv+c (a, b, c are constants)

On the other hand, the amount of change ΔEh of the potential energy becomes as in the following formula by the difference in altitude Δh between the current position and the reached position:

ΔEh=mgΔh (“m” is the mass of the vehicle 1, while “g” is the gravitational acceleration)

Further, the amount of change ΔEv of the kinetic energy becomes as in the following formula when designating the current vehicle speed as v₀ and the vehicle speed when reaching the designation as “v”:

ΔEh=1/2·m(v²−v₀²)

On the other hand, if approximating the conversion efficiency when the output of the battery 3 is converted to mechanical output by the constant μ, the energy ΔEb taken out from the battery 3 until reaching the boundary GF from the current position becomes as in the following formula:

ΔEb=EX/μ

On the other hand, if the charge capacity of the battery 3 is designated as Q and the output voltage of the battery 3 is approximated by the constant V, the energy Eq held by the battery 3 becomes as in the following formula:

Eq=QV

Therefore, the decreased SOC amount ΔSOC is expressed by the following formula:

ΔSOC=ΔEb/Eq

In this way, the decreased SOC amount ΔSOC is calculated. Note that, in calculating the decreased SOC amount ΔSOC, the difference in altitude Δh is calculated based on the map database stored in the map database storage device 10 and the vehicle speed “v” is made the legal speed on the searched shortest route.

Note that, strictly speaking, the conversion efficiency, that is, the constant μ, depends on the drive output and the vehicle speed “v” of the vehicle 1, so ΔEb becomes a function of the drive output and the vehicle speed “v” of the vehicle 1, and the output voltage V of the battery 3 depends on the SOC amount, so Eq becomes a function of the SOC amount. Therefore, when strictly finding the decreased SOC amount ΔSOC, the decreased SOC amount ΔSOC is calculated considering the changes in the drive output, the vehicle speed “v”, and the SOC of the vehicle 1. Note that, the explanation of the method of calculation of the decreased SOC amount ΔSOC when strictly finding the decreased SOC amount will be omitted here.

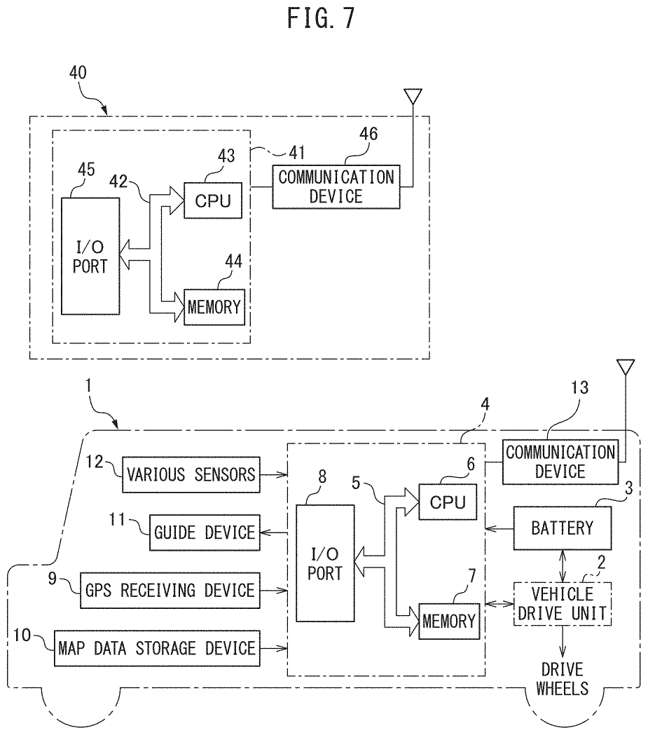

FIG. 7 shows the case where in addition to the vehicle 1, a server 40 is set outside of the vehicle 1 and where the vehicle 1 and the server 40 communicate. Referring to FIG. 7, in the same way as the vehicle 1 shown in FIG. 1, in the vehicle 1, the vehicle drive unit 2, battery 3, electronic control unit 4, GPS receiving device 9, map database storage device 10, guidance device 11 comprised of a navigation system, and various sensors 12 are mounted. Further, in the vehicle 1, a communication device 13 for communicating with the server 40 is mounted.

On the other hand, inside the server 40, an electronic control unit 41 is set. This electronic control unit 41 is comprised of a digital computer provided with a CPU (microprocessor) 43, a memory 44 comprised of a ROM and RAM, and an input/output port 45, which are connected to each other via a bidirectional bus 42. Further, inside the server 40, a communication device 46 for communicating with the vehicle 1 is set. In the example shown in FIG. 7, information relating to the boundary GF of the inside of the engine drive restriction zone and the outside of the engine drive restriction zone, that is, information relating to the geofencing, is stored in the memory 44 of the server 40. The information relating to the boundary GF, that is, the geofencing, is transmitted from the server 40 to the vehicle 1.

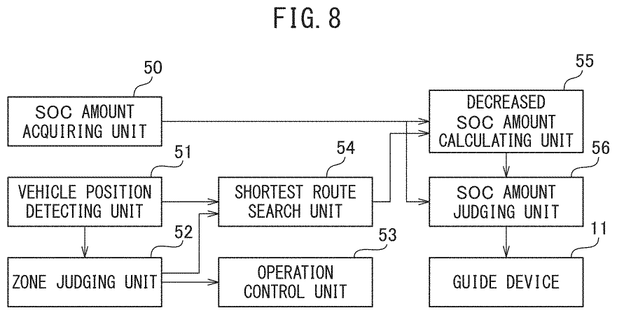

FIG. 8 is a view of the functional configuration of the first embodiment according to the present invention. If referring to FIG. 8, in this first embodiment according to the present invention, in the hybrid vehicle 1 driven by only the electric motor 21 or driven by both of the electric motor 21 and the internal combustion engine 20, there are provided in the electronic control unit 4 an SOC amount acquiring unit 50 acquiring an SOC amount of the battery 3 which is a source of supply of electric power to the electric motor 21, a vehicle position detecting unit 51 detecting the current position of the vehicle 1, a zone judging unit 52 judging if currently the vehicle 1 is driving through the inside of the engine drive restriction zone where driving by the internal combustion engine 20 is restricted, an operation control unit 53 making the internal combustion engine 20 stop operating and making the electric motor 21 drive the vehicle 1 when it is judged that currently the vehicle 1 is driving through the engine drive restriction zone, a shortest route searching unit 54 searching for a shortest route from the current position to the boundary of the inside of the engine drive restriction zone and the outside of the engine drive restriction zone when it is judged that currently the vehicle 1 is driving through the inside of the engine drive restriction zone, a decreased SOC amount calculating unit 55 calculating the decreased SOC amount when driving the vehicle 1 through the searched shortest route from the current position to the boundary GF, and an SOC amount judging unit 56 judging if the SOC amount will fall to the preset judgment standard SOCZ when driving the vehicle 1 through the searched shortest route from the current position to the boundary GF based on the current SOC amount and the calculated decreased SOC amount. Further, inside the vehicle 1, the guidance device 11 is mounted for providing information to an occupant of the vehicle 1 to guide the vehicle 1 from the current position through the searched shortest route to the boundary GF in case where it is judged that the SOC amount will fall to the judgment standard SOCZ when driving the vehicle 1 through the searched shortest route from the current position to the boundary GF.

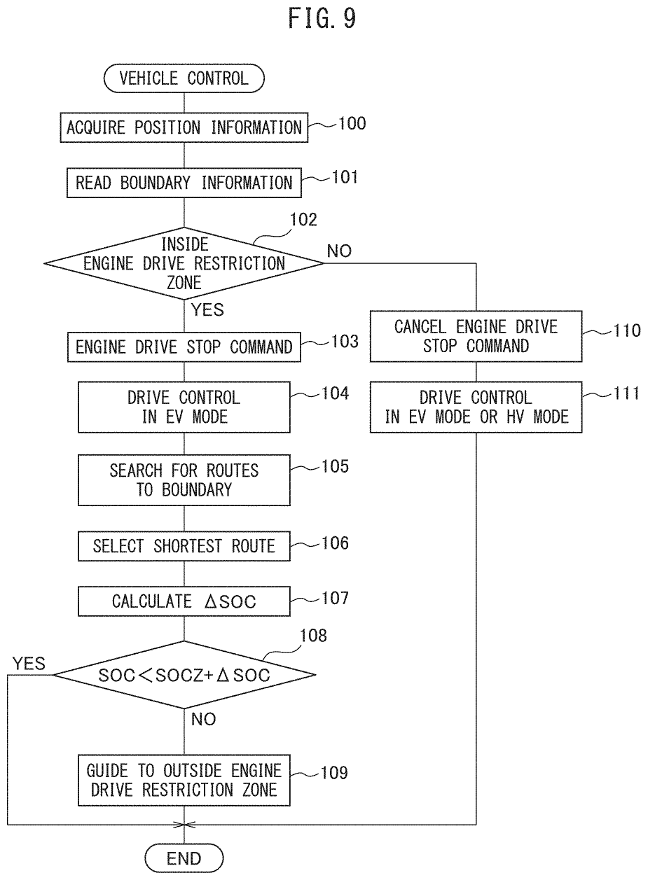

FIG. 9 shows a vehicle control routine performed in the CPU 6 of the electronic control unit 4 mounted in the vehicle 1 for working the first embodiment according to the present invention. This routine is performed by interruption every fixed time period.

Referring to FIG. 9, first, at step 100, the current position of the vehicle 1 is acquired based on received signals received from the GPS receiving device 9 and the map database stored in the map database storage device 10. Next, at step 101, the road positions Kd, Ke, Kf, Kg, etc. positioned on the boundary GF between the inside of the engine drive restriction zone and the outside of the engine drive restriction zone and other information relating to the boundary GF is read. In this case, in the example shown in FIG. 1, the information relating to this boundary GF is stored in the map database storage device 10. Therefore, in the example shown in FIG. 1, at step 101, the information relating to the boundary GF stored in the map database storage device 10 is read. On the other hand, in the example shown in FIG. 7, the information relating to the boundary GF is stored in the server 40. Therefore, in the example shown in FIG. 7, information relating to the boundary GF transmitted from the server 40 to the vehicle 1 is read in at step 101.

Next, at step 102, it is judged if currently the vehicle 1 is driving through the inside of the engine drive restriction zone where driving by the internal combustion engine 20 is restricted based on the acquired current position of the vehicle 1 and information relating to the boundary GF. When it is judged that currently the vehicle 1 is driving through the inside of an engine drive restriction zone, the routine proceeds to step 103 where a command for stopping driving by the internal combustion engine 20 is issued. If the command for stopping driving by the internal combustion engine 20 is issued, the routine proceeds to step 104 where operational control where the internal combustion engine 20 is made to stop operating and the electric motor 21 is used to drive the vehicle 1 is continued until the command for stopping driving by the internal combustion engine 20 is cancelled. That is, at this time, operational control is performed in the EV mode where the vehicle 1 is driven by only the electric motor 21.

Next, at step 105, the routes from the current position to the boundary GF are searched through. The search operation of these routes is performed by the navigation system. Next, at step 106, the shortest route from the current position to the boundary GF is selected from these routes. That is, at step 105 and step 106, the shortest route from the current position to the boundary GF is searched. If the shortest route from the current position to the boundary GF is searched, the routine proceeds to step 107 where the decreased SOC amount ΔSOC is calculated by using the above-mentioned method of calculation. Next, at step 108, the current SOC amount SOC calculated in the charging control routine of the battery 3 shown in the FIG. 4 is read and it is judged if the current SOC amount SOC is less than the value (SOCZ+ΔSOC) of the judgment standard SOCZ plus the calculated decreased SOC amount ΔSOC.

When it is judged that the current SOC amount SOC is not less than the value (SOCZ+ΔSOC) of the judgment standard SOCZ plus the calculated decreased SOC amount ΔSOC, that is, when there is an extra margin of the SOC amount SOC when driving the vehicle 1 from the current position to the boundary GF from the judgment standard SOCZ, the processing cycle is ended. As opposed to this, when it is judged that the current SOC amount SOC is less than the value (SOCZ+ΔSOC) of the judgment standard SOCZ plus the calculated decreased SOC amount ΔSOC, the routine proceeds to step 109 where guidance processing is performed to use the guidance device 11 to provide information to the occupant of the vehicle 1 by an image or voice and guide the vehicle 1 from the current position through the searched shortest route to the boundary GF. Next, the processing cycle is ended.

On the other hand, if at step 102 it is judged that currently the vehicle 1 is not driving through the inside of the engine drive restriction zone, the routine proceeds to step 110 where the command for stopping driving by the internal combustion engine 20 is cancelled. If the command for stopping driving by the internal combustion engine 20 is cancelled, driving by the internal combustion engine 20 becomes possible. Next, at step 111, drive control is performed in accordance with the drive state of the vehicle 1 by either mode of the EV mode where the vehicle 1 is driven by only the electric motor 21 and the HV mode where the vehicle 1 is driven by both of the internal combustion engine 20 and electric motor 21. Note that, at this time, the internal combustion engine 20 can be used to drive the generator 23 to charge the battery 3.

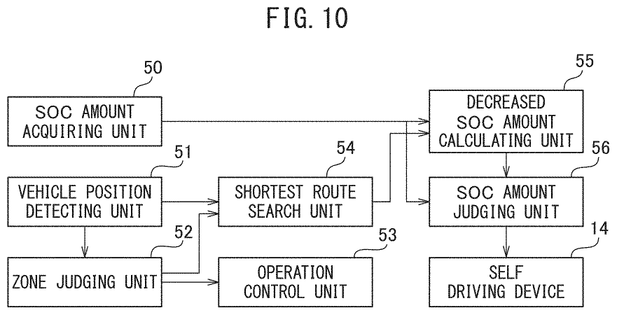

FIG. 10 to FIG. 12 show a second embodiment in the case of applying the present invention to a self driving hybrid vehicle provided with a self driving device. In this second embodiment, a self driving device is mounted in the vehicle 1 shown in FIG. 1 and FIG. 7. As the various sensors 12, a forward capture camera, side capture cameras, rear capture camera, radar, LIDAR, etc. required for self driving are mounted. Also, a steering control device is mounted.

In this second embodiment as well, in the same way as the first embodiment, it continues to be judged if the SOC amount will fall to the judgment standard SOCZ shown in FIG. 6 when driving the vehicle 1 through the searched shortest route from the current position to the boundary GF. On the other hand, when it is judged that the SOC amount will fall to the judgment standard SOCZ, in this second embodiment, unlike the first embodiment, the vehicle 1 is autonomously driven by the self driving device from the current position through the searched shortest route to the boundary GF.

FIG. 10 is a view of the functional configuration of the second embodiment according to the present invention. If referring to FIG. 10, in this second embodiment as well, in the same way as the first embodiment, in the hybrid vehicle 1 driven by only the electric motor 21 or driven by both of the electric motor 21 and the internal combustion engine 20, there are provided in the electronic control unit 4 an SOC amount acquiring unit 50 acquiring an SOC amount of the battery 3 which is a source of supply of electric power to the electric motor 21, a vehicle position detecting unit 51 detecting the current position of the vehicle 1, a zone judging unit 52 judging if currently the vehicle 1 is driving through the inside of the engine drive restriction zone where driving by the internal combustion engine 20 is restricted, an operation control unit 53 making the internal combustion engine 20 stop operating and making the electric motor 21 drive the vehicle 1 when it is judged that currently the vehicle 1 is driving through the engine drive restriction zone, a shortest route searching unit 54 searching for a shortest route from the current position to the boundary of the inside of the engine drive restriction zone and the outside of the engine drive restriction zone when it is judged that currently the vehicle 1 is driving through the inside of the engine drive restriction zone, a decreased SOC amount calculating unit 55 calculating the decreased SOC amount when driving the vehicle 1 through the searched shortest route from the current position to the boundary GF, and an SOC amount judging unit 56 judging if the SOC amount will fall to the preset judgment standard SOCZ when driving the vehicle 1 through the searched shortest route from the current position to the boundary GF based on the current SOC amount and the calculated decreased SOC amount.

On the other hand, in this second embodiment, unlike the first embodiment, inside the vehicle 1, a self driving device 14 is mounted for autonomously driving the vehicle 1 from the current position through the searched shortest route to the boundary GF in case where it is judged that the SOC amount will fall to the preset judgment standard SOCZ when driving the vehicle through the searched shortest route from the current position to the boundary GF. This self driving device 14 is controlled by the electronic control unit 4.

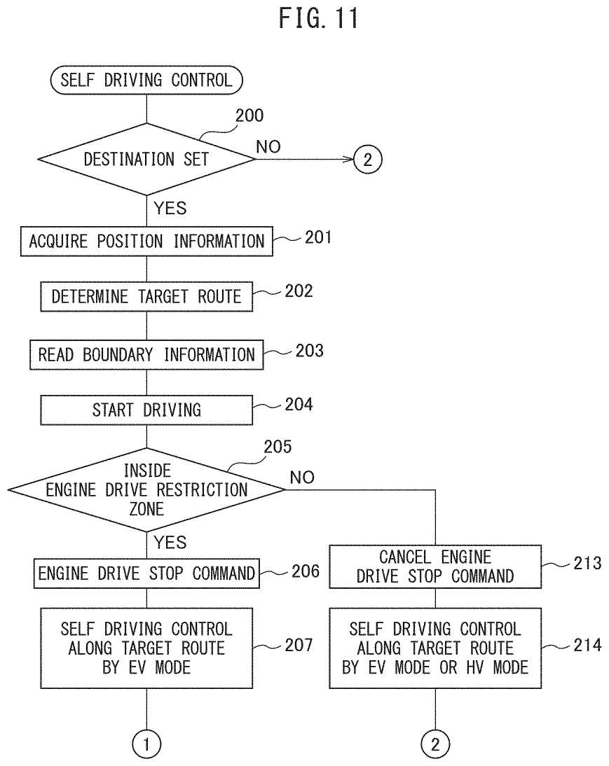

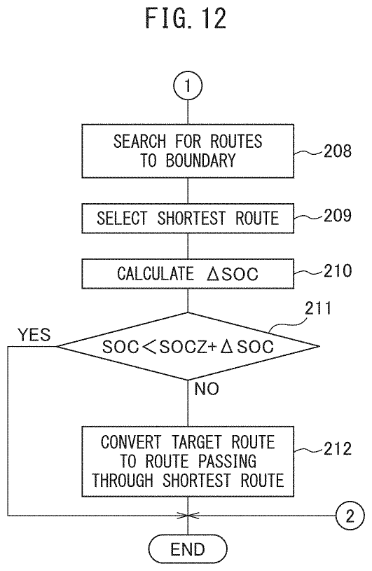

FIG. 11 and FIG. 12 show a self driving control routine performed in the CPU 6 of the electronic control unit 4 mounted in the vehicle 1 for working this second embodiment. This routine is performed by interruption every fixed time period.

Referring to FIG. 11, first, at step 200, for example, it is judged if an occupant has set a destination on the operating screen of the self driving device 14. When it is judged that a destination has not been set, the processing cycle is ended. As opposed to this, when it is judged that a destination has been set, the routine proceeds to step 201 where the current position of the vehicle 1 is acquired based on received signals received from the GPS receiving device 9 and the map database stored in the map database storage device 10. Next, at step 202, the target route is determined by the navigation system. Next, at step 203, information relating to the boundary GF stored in the map database storage device 10 or the information relating to the boundary GF transmitted from the server 40 to the vehicle 1 are read.

Next, at step 204, the vehicle 1 starts to be driven by self driving. If the vehicle 1 starts to be driven, the routine proceeds to step 205 where it is judged if currently the vehicle 1 is driving through the inside of the engine drive restriction zone where driving by the internal combustion engine 20 is restricted based on the acquired current position of the vehicle 1 and information relating to the boundary GF. When it is judged that currently the vehicle 1 is driving through the inside of the engine drive restriction zone, the routine proceeds to step 206 where a command for stopping driving by the internal combustion engine 20 is issued. If the command for stopping driving by the internal combustion engine 20 is issued, the routine proceeds to step 207 where the self driving control where the internal combustion engine 20 is made to stop operating and the electric motor 21 is used to drive the vehicle 1 is continued until the command for stopping driving by the internal combustion engine 20 is cancelled. That is, at this time, self driving control is performed in the EV mode where the vehicle 1 is driven by only the electric motor 21.

Next, at step 208, the routes from the current position to the boundary GF are searched through. The search operation of these routes is performed by the navigation system. Next, at step 209, the shortest route from the current position to the boundary GF is selected from these routes. That is, at step 208 and step 209, the shortest route from the current position to the boundary GF is searched. If the shortest route from the current position to the boundary GF is searched, the routine proceeds to step 210 where the decreased SOC amount ΔSOC is calculated by using the above-mentioned method of calculation. Next, at step 211, the current SOC amount SOC calculated in the charging control routine of the battery 3 shown in the FIG. 4 is read and it is judged if the current SOC amount SOC is less than the value (SOCZ+ΔSOC) of the judgment standard SOCZ plus the calculated decreased SOC amount ΔSOC.

When it is judged that the current SOC amount SOC is not less than the value (SOCZ+ΔSOC) of the judgment standard SOCZ plus the calculated decreased SOC amount ΔSOC, that is, when there is an extra margin of the SOC amount SOC when driving the vehicle 1 from the current position to the boundary GF from the judgment standard SOCZ, the processing cycle is ended. As opposed to this, when it is judged that the current SOC amount SOC is less than the value (SOCZ+ΔSOC) of the judgment standard SOCZ plus the calculated decreased SOC amount ΔSOC, the routine proceeds to step 212 where the target route is changed to the searched shortest route and self driving control is performed for autonomously driving the vehicle 1 from the current position through the searched shortest route to the boundary GF. Next, the processing cycle is ended.

On the other hand, when at step 205 it is judged that currently the vehicle 1 is not driven through the inside of the engine drive restriction zone, the routine proceeds to step 213 where the command stopping the drive operation by the internal combustion engine 20 is cancelled. If the command stopping the drive operation by the internal combustion engine 20 is cancelled, the drive operation by the internal combustion engine 20 becomes possible. Next, at step 214, in accordance with the operating state of the vehicle 1, self driving is controlled by either of the modes of an EV mode where the vehicle 1 is driven by only the electric motor 21 and an HV mode where the vehicle 1 is driven by both of the internal combustion engine 20 and the electric motor 21.

1. A vehicle drive route instruction system in a hybrid vehicle driven by only an electric motor or driven by both an electric motor and an internal combustion engine, said vehicle drive route instruction system comprising:
an SOC amount acquiring unit acquiring an SOC amount of a battery which is a source of supply of electric power to the electric motor,
a vehicle position detecting unit detecting a current position of the vehicle,
a zone judging unit judging if currently the vehicle is driving through an inside of an engine drive restriction zone where driving by the internal combustion engine is restricted,
an operation control unit making the internal combustion engine stop operating and making the electric motor drive the vehicle when it is judged that currently the vehicle is driving through the engine drive restriction zone,
a shortest route searching unit searching for a shortest route from the current position to a boundary of an inside of the engine drive restriction zone and an outside of the engine drive restriction zone when it is judged that currently the vehicle is driving through the inside of the engine drive restriction zone,
a decreased SOC amount calculating unit calculating a decreased SOC amount when driving the vehicle through the searched shortest route from the current position to the boundary,
an SOC amount judging unit judging if the SOC amount will fall to a preset judgment standard based on the current SOC amount and the calculated decreased SOC amount when driving the vehicle through the searched shortest route from the current position to the boundary based, and
a guidance device giving information to an occupant of the vehicle to guide the vehicle from the current position through the searched shortest route to the boundary in case where it is judged that the SOC amount will fall to the judgment standard when driving the vehicle through the searched shortest route from the current position to the boundary.

2. The vehicle drive route instruction system according to claim 1 wherein the hybrid vehicle is a vehicle which is selectively switched to either mode of a mode where the vehicle is driven by only the electric motor and a mode where the vehicle is driven by both of the internal combustion engine and electric motor or a vehicle which is driven by only the electric motor and the internal combustion engine is used only for driving a generator to charge the battery.

3. The vehicle drive route instruction system according to claim 1 wherein the judgment standard is set to a value larger than a preset lower limit value of the SOC amount by exactly a fixed value.

4. The vehicle drive route instruction system according to claim 1 wherein the SOC amount judging unit judges that the SOC amount will fall to the preset judgment standard when driving the vehicle through the searched shortest route from the current position to the boundary by judging if the current SOC amount falls below a value of the judgment standard plus the calculated decreased SOC amount, and the guidance device gives information to an occupant of the vehicle to guide the vehicle from the current position through the searched shortest route to the boundary when it is judged that the current SOC amount falls below the value of the judgment standard plus the calculated decreased SOC amount.

5. The vehicle drive route instruction system according to claim 1 wherein the guidance device is provided with a display unit displaying a driving route of the vehicle, and the guidance device displays the searched shortest route at the display unit in case where it is judged by the SOC amount judging unit that the SOC amount will fall to the judgment standard when driving the vehicle through the searched shortest route from the current position to the boundary.

6. The vehicle drive route instruction system according to claim 1 wherein the guidance device is provided with a speech generating unit explaining a drive route of the vehicle by voice and the guidance device provides voice guidance of the searched shortest route in case where it is judged by the SOC amount judging unit that the SOC amount will fall to the judgment standard when driving the vehicle through the searched shortest route from the current position to the boundary.

7. A vehicle drive route instruction system in a hybrid vehicle driven by only an electric motor or driven by both an electric motor and an internal combustion engine, said vehicle drive route instruction system comprising:
an SOC amount acquiring unit acquiring an SOC amount of a battery which is a source of supply of electric power to the electric motor,
a vehicle position detecting unit detecting a current position of the vehicle,
a zone judging unit judging if currently the vehicle is driving through an inside of an engine drive restriction zone where driving by the internal combustion engine is restricted,
an operation control unit making the internal combustion engine stop operating and making the electric motor drive the vehicle when it is judged that currently the vehicle is driving through the engine drive restriction zone,
a shortest route searching unit searching for a shortest route from the current position to a boundary of an inside of the engine drive restriction zone and an outside of the engine drive restriction zone when it is judged that currently the vehicle is driving through the inside of the engine drive restriction zone,
a decreased SOC amount calculating unit calculating a decreased SOC amount when driving the vehicle through the searched shortest route from the current position to the boundary,
an SOC amount judging unit judging if the SOC amount will fall to a preset judgment standard based on the current SOC amount and the calculated decreased SOC amount when driving the vehicle through the searched shortest route from the current position to the boundary based, and
a self driving device autonomously driving the vehicle through the searched shortest route from the current position to the boundary in case where it is judged that the SOC amount will fall to the judgment standard when driving the vehicle through the searched shortest route from the current position to the boundary.

8. The vehicle drive route instruction system according to claim 7 wherein the hybrid vehicle is a vehicle which is selectively switched to either mode of a mode where the vehicle is driven by only the electric motor and a mode where the vehicle is driven by both of the internal combustion engine and electric motor or a vehicle which is driven by only the electric motor and the internal combustion engine is used only for driving a generator to charge the battery.

9. The vehicle drive route instruction system according to claim 7 wherein the judgment standard is set to a value larger than a preset lower limit value of the SOC amount by exactly a fixed value.

10. The vehicle drive route instruction system according to claim 7 wherein the SOC amount judging unit judges that the SOC amount will fall to the preset judgment standard when driving the vehicle through the searched shortest route from the current position to the boundary by judging if the current SOC amount falls below a value of the judgment standard plus the calculated decreased SOC amount, and the self driving device autonomously drives the vehicle from the current position through the searched shortest route to the boundary when it is judged that the current SOC amount falls below the value of the judgment standard plus the calculated decreased SOC amount.
